(19) United States
(12) Patent Application Publication
(10) Pub. No.: US 2018/0314993 A1
(43) Pub. Date: Nov. 1, 2018

(54) FRAMEWORK AND TOOL FOR MODELING AND ASSESSING DESIGN-CENTRIC READINESS

(71) Applicant: SAP SE, Walldorf (DE)

(72) Inventors: Janaki Kumar, Palo Alto, CA (US); Andreas Hauser, Dielheim (DE); Tai-Chia Tuan, Palo Alto, CA (US); Sally Lawler Kennedy, Boulder Creek, CA (US); Susan Kuypers, San Carlos, CA (US); Carol Farnsworth, Santa Clara, CA (US); Jerry John, Newark, CA (US); Marcos Martinez, San Jose, CA (US)

(21) Appl. No.: 15/583,699

(22) Filed: May 1, 2017

(51) Int. Cl. G06Q 10/06

(52) U.S. Cl. CPC G06Q 10/063; G06Q 10/0637; G06Q 10/0639

(57) ABSTRACT

In one general aspect, a method can include transmitting, by a first computer system and to a second computer system, a request for processed survey data for a survey, the second computer system having access to a local repository for storing the processed survey data, the processed survey data being generated by a survey data processor included in the second computer system, receiving, by the first computer system and from the second computer system, the processed survey data, executing, by the first computer system, an enhanced end-of-survey generator for generating an enhanced end-of-survey report using the received process survey data, the enhanced end-of-survey report including information about an innovation readiness for an organization, and sending, by the first computer system and to the first computing device, the enhanced end-of-survey report for display on a display device included in the first computing device.

### TECHNICAL FIELD

This description generally relates to the design and implementation of a design-centric readiness framework and assessment tool for use in modeling and assessing design-centric readiness.

### BACKGROUND

In general, a design driven (or design-centric or design-led) organization can experience a measured increased in performance as compared to organizations that are not design driven. A design driven organization can implement a culture of innovation that involves a favorable combination of processes, physical space, and people across the organization. The design driven organization can implement a workplace that encourages and responds quickly to changing dynamics in both business and technology while fostering the empowerment of individuals across the organization.

### SUMMARY

According to one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a general aspect, a method can include, in a system including one or more computing devices in communication with one or more computer systems over a network, transmitting, by a first computer system and to a second computer system, a request for processed survey data for a survey, the second computer system having access to a local repository for storing the processed survey data, the processed survey data being generated by a survey data processor included in the second computer system, receiving, by the first computer system and from the second computer system, the processed survey data, executing, by the first computer system, an enhanced end-of-survey generator for generating an enhanced end-of-survey report using the received process survey data, the enhanced end-of-survey report including information about an innovation readiness for an organization, and sending, by the first computer system and to the first computing device, the enhanced end-of-survey report for display on a display device included in the first computing device.

In another general aspect, a non-transitory, machine-readable medium can have instructions stored thereon. The instructions, when executed by a processor, can cause a first computer system to transmit, by the first computer system and to a second computer system, a request for processed survey data for a survey, the second computer system having access to a local repository for storing the processed survey data, the processed survey data being generated by a survey data processor included in the second computer system, receive, by the first computer system and from the second computer system, the processed survey data, execute an enhanced end-of-survey generator for generating an enhanced end-of-survey report using the received process survey data, the enhanced end-of-survey report including information about an innovation readiness for an organization, and send, by the first computer system and to the first computing device, the enhanced end-of-survey report for display on a display device included in the first computing device.

In yet another general aspect, a system can include a network, a first computer system including an enhanced end-of-survey generator, a second computer system including a second repository and a survey data processor, the second repository including stored processed survey data, and a first computing device including a display device. The first computer system can be configured to transmit a request for processed survey data for a survey to the second computer system by way of the network, the second computer system accessing the second repository to retrieve the processed survey data, the processed survey data being generated by the survey data processor, receive the processed survey data from the second computer system, execute the enhanced end-of-survey generator, the executing generating an enhanced end-of-survey report using the received process survey data, the enhanced end-of-survey report including information about an innovation readiness for an organization, and send the enhanced end-of-survey report to the first computing device by way of the network for display on the display device.

Implementations may include one or more of the following features. For example, generating the processed survey data by the survey data processor can include identifying a score for each answer to each question included in the survey. Generating the processed survey data by the survey data processor can further include calculating a raw score using the identified scores for each answer to each question included in the survey. Generating the processed survey data by the survey data processor can further include calculating a percentage score, and calculating a stage. The raw score, the percentage score, and the stage can represent innovation readiness for an organization. The method can further include receiving, by the first computer system and from a second computing device, instructions for handling the processed survey data prior to transmitting a request for processed survey data for the survey. The method can further include storing the enhanced end-of-survey report in a local repository accessible by the first computer system. The instructions, when executed by a processor, can further cause a first computer system to receive, by the first computer system and from a second computing device, instructions for handling the processed survey data prior to transmitting a request for processed survey data for the survey. The instructions, when executed by a processor, can further cause a first computer system to store the enhanced end-of-survey report in a local repository accessible by the first computer system. The first computer system can include a first repository. The first computer system can be further configured to store the enhanced end-of-survey report in the first repository

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that can be used to provide an innovation readiness framework and model.

FIG. 2 is swimlane diagram showing interactions between an administrator computing device, a first computer system, and a second computer system.

FIGS. 3A-B is swimlane diagram showing interactions 300 between a user computing device, a first computer system, and a second computer system.

FIG. 4 is a swimlane diagram showing interactions between a user computing device, an administrator computing device, a first computer system, and a second computer system.

FIGS. 5A-B show an example innovation readiness assessment survey.

FIGS. 6A-C show an example enhanced version of an end-of-survey report.

FIGS. 7A-B show two examples tables.

FIG. 8 is a flowchart that illustrates a method for generating an enhanced end-of-survey report.

Like reference symbols in the various drawings indicate like elements.

### DETAILED DESCRIPTION

In general, research indicates that a design driven organization outperforms organizations that are not design driven. An innovation readiness framework and assessment tool can be used to show where an organization, group, or team falls within a design-centric readiness model. The design-centric readiness model can include identified measureable pillars to achieving a culture of innovation such as people, processes, and places. An innovation readiness framework can identify stages that can lead towards innovation readiness such as interest, investment, engagement, and scaling.

The innovation readiness framework and assessment tool can provide an assessment of the innovation readiness for an organization based on answers to survey questions provided to the organization. The survey can include questions directed towards the identified measureable pillars. The answers to the questions can be scored based on prior information, research, and knowledge of good practices for achieving a design-centric organization. For example, the assessment can be performed using a web-based application that includes automated scoring and reporting. The results of the assessment can be provided to an organization, for example, as an executive summary.

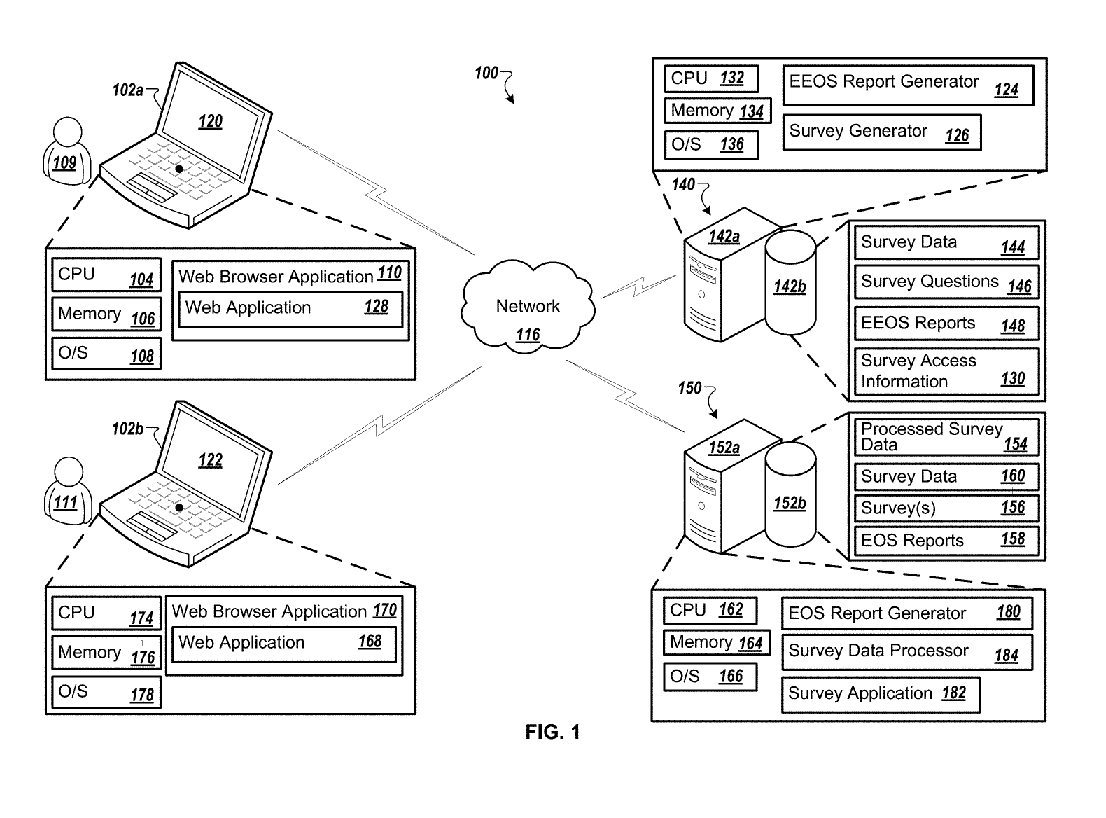

FIG. 1 is a diagram of an example system 100 that can be used to provide an innovation readiness framework and model. The example system 100 includes a computing devices 102a-b. Though shown as, for example, laptop computing devices, each of the computing devices 102a-b can include, but are not limited to a laptop computer, a notebook computer, a tablet computer, a smartphone, a personal digital assistant, or a desktop computer.

For example, a user 109 can use the computing device 102a to access, interact with, and respond to a survey regarding innovation readiness for an company, organization, group, or team. The user 109 can use the computing device 102a to access the results of the survey. The example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110. The web browser application 110 can display a user interface (UI) (e.g., a web browser UI) on a display device 120 included in the computing device 102a. The user 109 can interact with the web browser UI to access an online survey.

The system 100 can include a first computer system 140 that can include one or more computing devices (e.g., a server 142a) and one or more computer-readable storage devices (e.g., repository 142b). In some implementations, the repository 142b can be a database. The system 100 can include a second computer system 150 that can include one or more computing devices (e.g., a server 152a) and one or more computer-readable storage devices (e.g., repository 152b). In some implementations, the repository 152b can be a database. The server 142a can include one or more processors (e.g., a server CPU 132), and one or more memory devices (e.g., a server memory 134). The server 152a can include one or more processors (e.g., a server CPU 162), and one or more memory devices (e.g., a server memory 164). The computing devices 102a-b, the computer system 140, and the computer system 150 can communicate with one another by way of a network 116. The server 142a can execute a server O/S 136 and the server 152a can execute server O/S 166. In some implementations, the second computer system 150 may be a vendor computer system.

For example, an administrator 111 can use the computing device 102b to create and manage a survey regarding innovation readiness for an company, organization, group, or team. The example computing device 102b can include one or more processors (e.g., a client central processing unit (CPU) 174) and one or more memory devices (e.g., a client memory 176). The computing device 102a can execute a client operating system (O/S) 178 and one or more client applications, such as a web browser application 170. The web browser application 170 can display a user interface (UI) (e.g., a web browser UI) on a display device 122 included in the computing device 102b.

As described herein, sending information and data between the computer system 140, the computer system 150, the computing device 102a and the computing device 102b can also be referred to as transmitting the information and data.

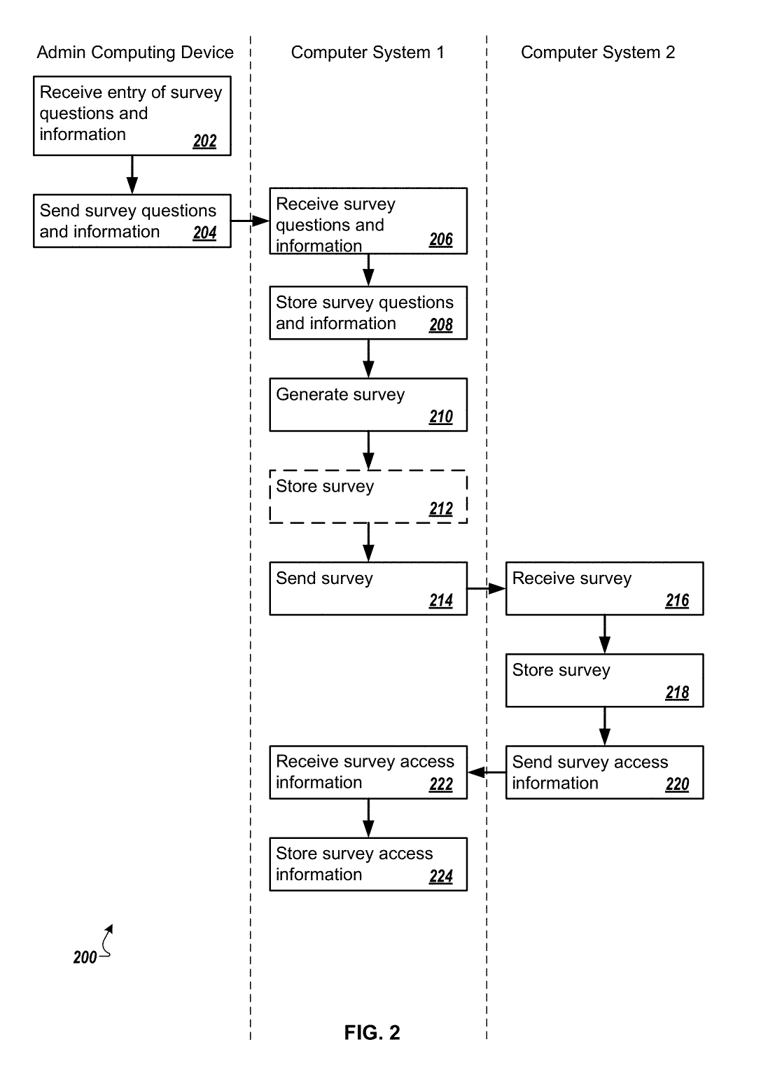

FIG. 2 is swimlane diagram showing interactions 200 between an administrator computing device (e.g., the computing device 102b), a first computer system (e.g., the computer system 140), and a second computer system (e.g., the computer system 150).

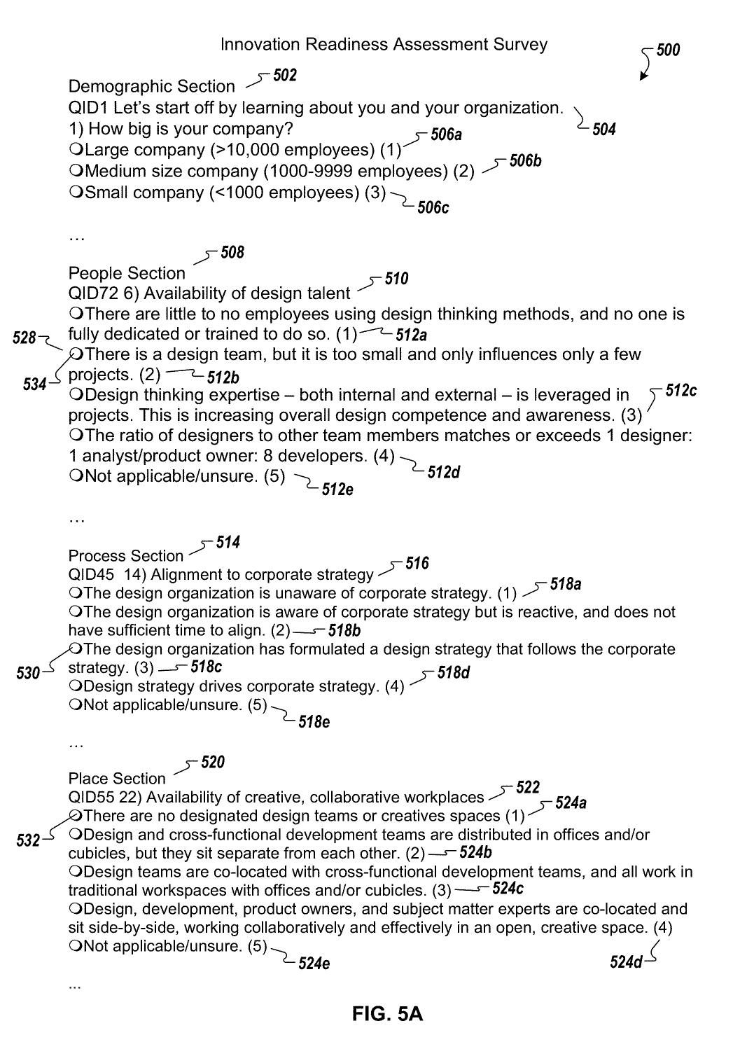

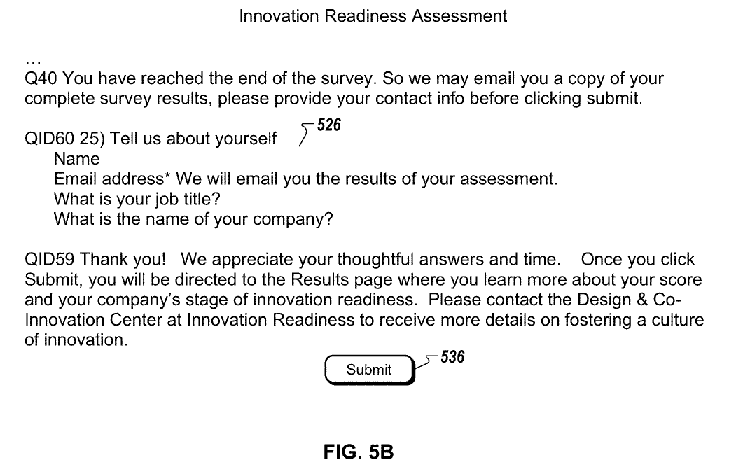

Referring to FIG. 1, the computing device 102b can receive entry of survey questions (202). For example, an administrator interacting with a web based application (e.g., a web application 168) executing in the web browser application 170 can create an innovation readiness assessment survey for use by users when establishing a design-centric readiness for an organization. The administrator can input questions, determine a score for each question, and otherwise format and provide information and data for use by the survey. An example of an innovation readiness assessment survey is shown herein with reference to FIGS. 5A-B.

The computing device 102b can send the survey questions and information to the computer system 140 (204). The computer system 140 can receive the survey questions and information (206). The computer system can save the survey questions and information (208). For example, the computing device 102b can select a submit entry or a save entry in the web based application that will initiate the sending of the questions and information entered in the web based application to the computer system 140 by way of the network 116. The computer system 140 can store the received survey questions and information in the repository 142b as stored survey questions and information 146. The computer system 140 can generate the innovation readiness assessment survey (referred to herein as the survey) (210).

For example, a survey generator 126 included in the server 142a can be executed. For example, the CPU 132 can execute instructions included in the survey generator 126. The survey generator 126 can access the survey questions and information 146 included in the repository 142b. The survey generator 126 can generate an innovation readiness assessment survey (e.g., an innovation readiness assessment survey 500 as shown in FIGS. 5A-B). Optionally, the computer system 140 may store the innovation readiness assessment survey (212). For example, the computer system 140 may store the innovation readiness assessment survey in the repository 142b. The survey can be in the form of a file that can be loaded in a web browser application. In some implementations, the survey can be in the form of a document file.

The computer system 140 can send the survey to the computer system 150 (214). The computer system 150 can receive the survey (216). The computer system 150 can store the survey (218). For example, the computer system 150 can store the innovation readiness assessment survey in the repository 152b as stored surveys 156. The stored surveys may later be accessed by the computing device 102b as well as the computing device 102a.

The computer system 150 can send information related to how to access the stored survey to the computer system 140 (220). For example, a universal resource locator (URL) can be associated with the stored survey. A user and/or administrator can use a web browser application to access the survey by providing the web browser application with the URL while the computing device executing the web browser application is in communication with (connected to) the network 116. The computer system 140 can receive the survey access information (222). The computer system 140 can store the survey access information (224). The computer system can store the survey access information (e.g., the URL associated with the survey) in the repository 142b as survey access information 130.

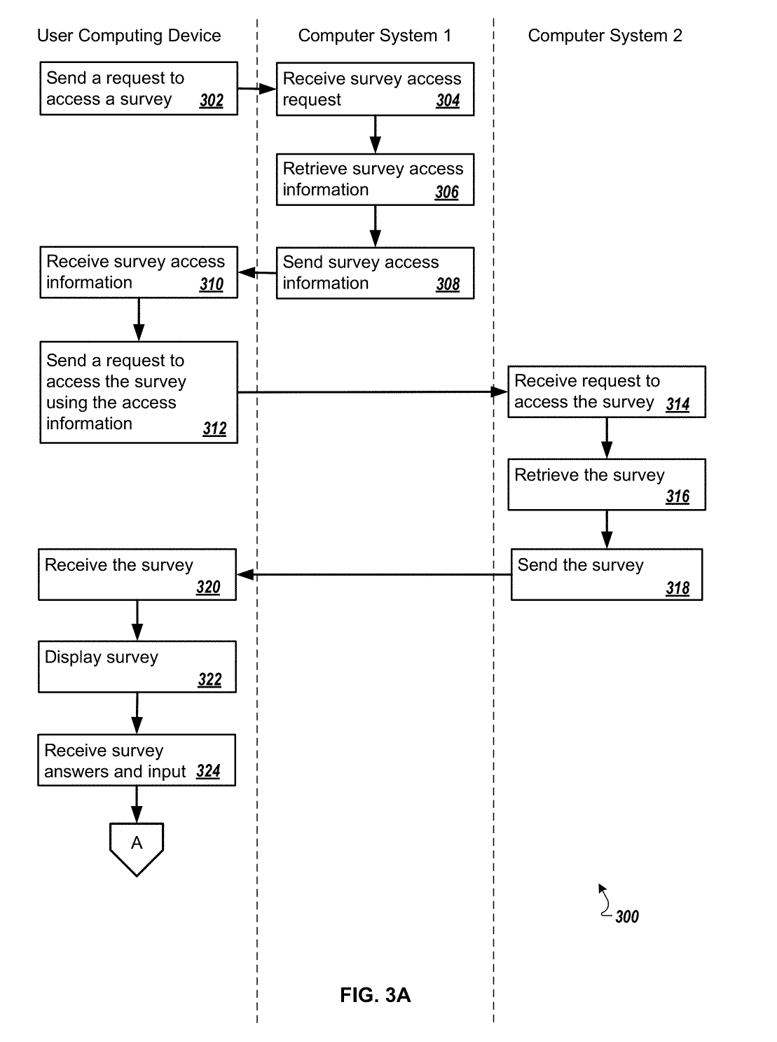

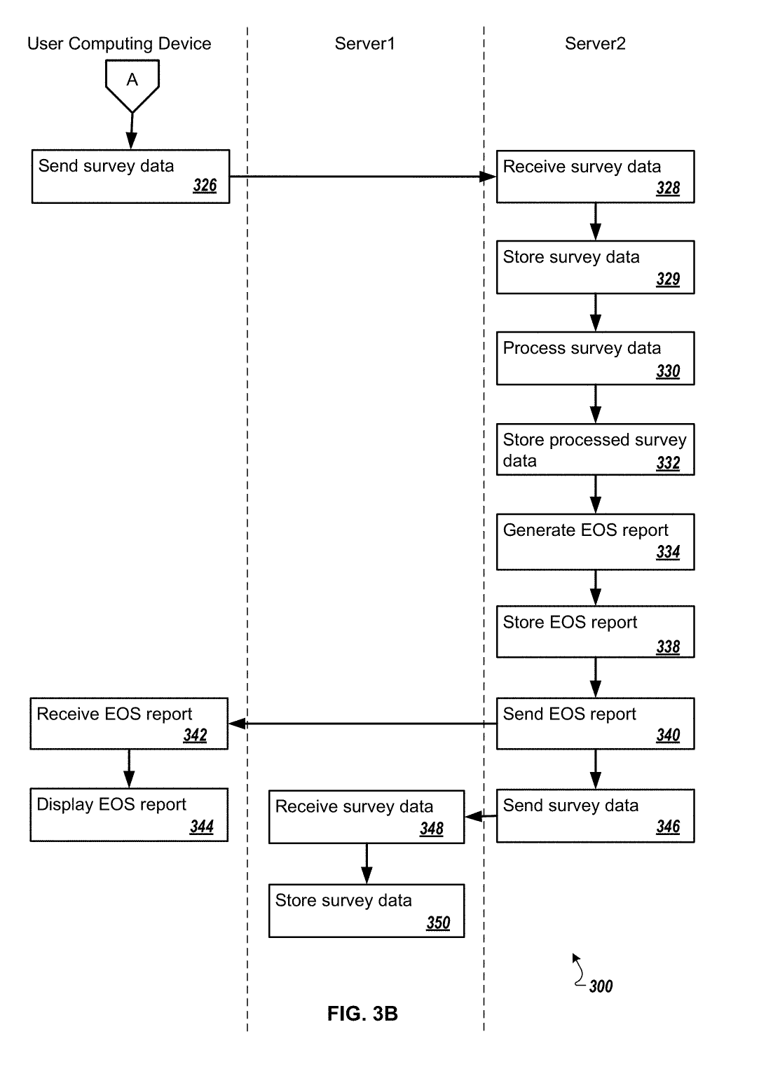

FIGS. 3A-B is swimlane diagram showing interactions 300 between a user computing device (e.g., the computing device 102a), a first computer system (e.g., the computer system 140), and a second computer system (e.g., the computer system 150).

Referring to FIG. 1 and FIG. 3A, the computing device 102a can send a request to access a survey the computer system 140 for a survey (302). For example, a user can interact with the web browser application 110 to navigate to a web page that allows for the selection of the survey for access. The computer system 140 can receive the survey access request (304). The computer system 140 can retrieve the survey access information (306). For example, the server 142a can access the survey access information 130 included in the repository 142b to obtain the access information (e.g., the URL) associated with the survey requested for access by the user (an innovation readiness assessment survey (e.g., the innovation readiness assessment survey 500 as shown in FIGS. 5A-B)). The computer system 140 can send the survey access information (e.g., the URL) to the computing device 102a (308). The computing device 102a can receive the survey access information (310). Using the received survey access information, the computing device 102a can send a request to access the survey (312). Based on the information included in the received survey access information (e.g., the URL), the computer system 150 will receive the request (314). The computer system 150 can retrieve the survey (316) (e.g., retrieve the web page for the survey). The computer system 150 can send the survey (318).

The computing device 102a can receive the survey (320). The computing device 102a can receive the survey as a web page for execution in a web application. The computing device 102a can display the survey on the display device 120 (322).

For example, a survey application 182 can receive the URL for the survey and can retrieve the survey from the survey(s) 156 included in the repository and provide the survey as a web page to the web browser application 110 executing on the computing device 102a. For example, the user can enter the URL into the web browser application 110 and be directed to a web page that includes the survey. The web browser application 110 can execute a web application that can provide the survey to the user in a user interface (UI) of the web application. The user can then interact with the survey, entering information and data, and selecting answers to the survey questions.

The computing device 102a can receive inputs to the survey and/or answers to survey questions (324). For example, referring to FIGS. 5A-B, a user can interact with the UI to provide answers to survey questions (e.g., select or click on a button 534 when selecting an answer 528 for a question ID72 510). For example, referring to FIG. 5B, a user can interact with the UI when providing input to requested user information 526.

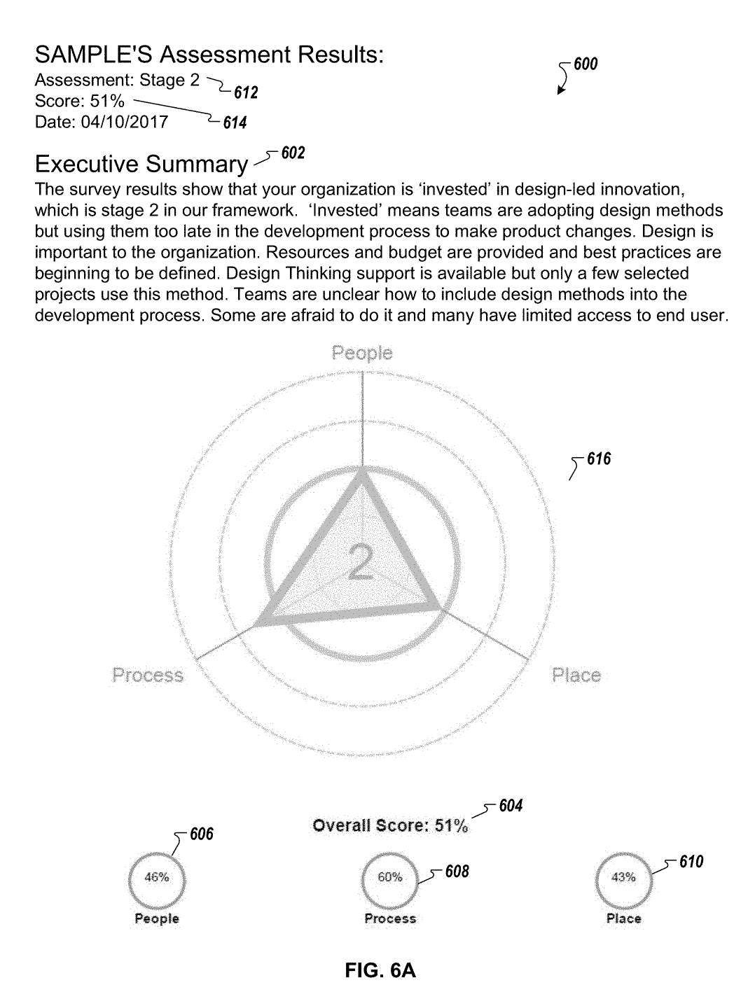

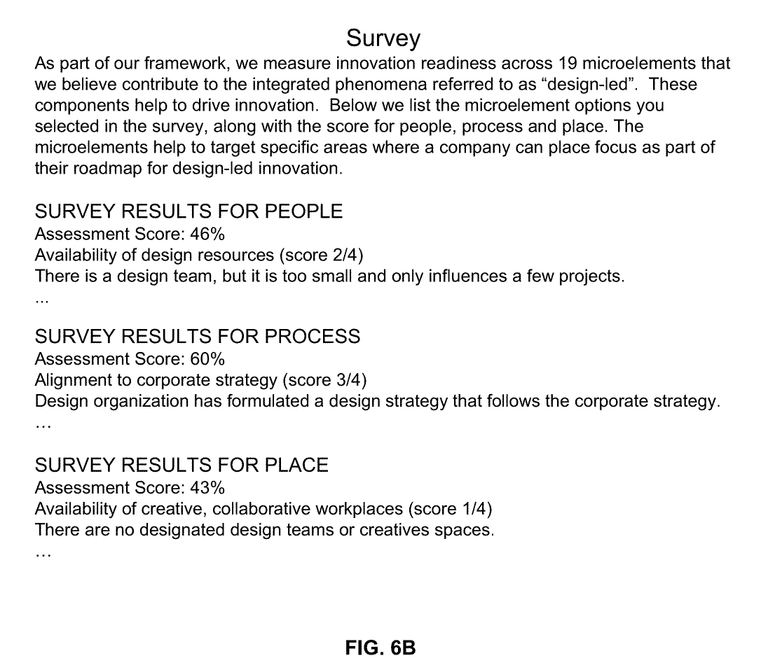

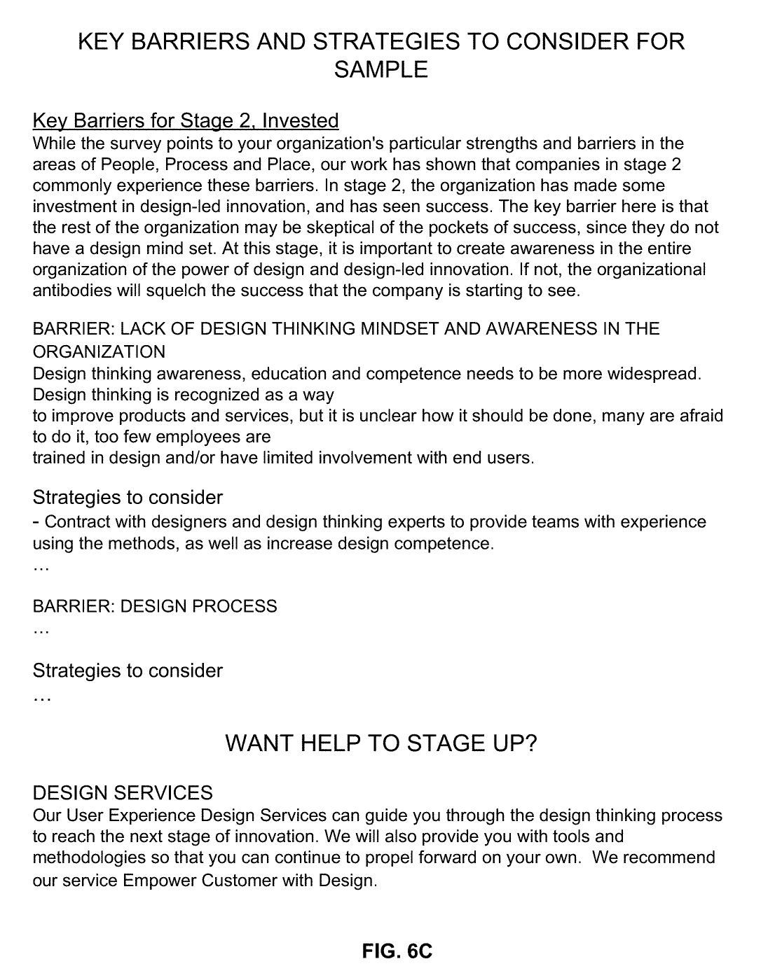

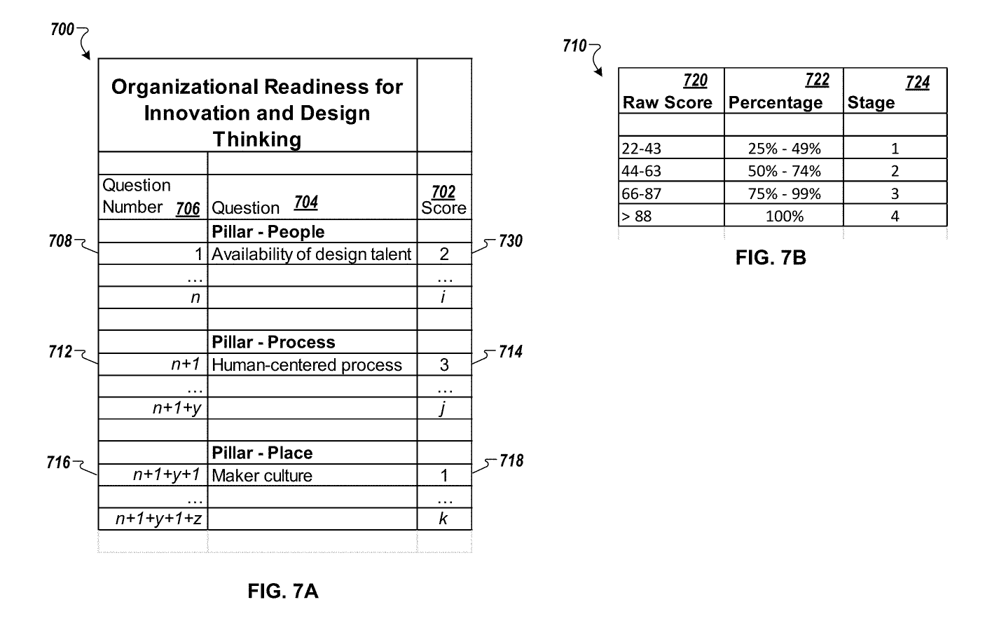

Referring to FIG. 3B, the computing device 102a can send the survey data to the computer system 150 (326). For example, referring to FIG. 5B, the survey can include a submit button 536. The user can click on (select) the submit button 536. The survey answers and information will be sent as survey data to the computer system 150. The computer system 150 can receive the survey data (328). The computer system 150 can store the survey data (329). The computer system 150 can store the survey data in the server memory 164 for access by a survey data processor 184. The computer system 150 can in addition or alternatively store the survey data in the repository 152b as survey data 160 for access by a survey data processor 184. The computer system 150 can process the survey data (330). For example, the survey data processor 184 can take the survey data and information (e.g., the answers to the survey questions and other information entered by the user into the survey) and determine the information needed for generating an end-of-survey (EOS) report. Referring to FIGS. 6A-C and FIGS. 7A-B, the survey data processor 184 can determine a score for each answer, can determine what answers are associated with each pillar, and can calculate a raw score, a percentage, and a stage for the organization based on the survey data. How the survey data processor 184 calculates the scores, percentages, and stages for reporting in an EOS report (as shown for example in FIGS. 6A-C) is described more with reference to FIGS. 6A-C and FIGS. 7A-B. The EOS report can provide information as the innovation readiness of the organization.

The server 152a can store the processed survey data in the repository 152b as processed survey data 154 (332).

For example, an EOS report generator 180 included in the server 152a can be executed. For example, the server CPU 162 can execute instructions included in the EOS report generator 180. The EOS report generator 180 can access the processed survey data when generating an EOS report (334). The server 152a can store the EOS report in the repository 152b as EOS reports 158 (338). The computer system 150 can send the EOS report to the computing device 102a (340). For example, the EOS report can include the data and information in an EEOS report 600 with the exception of a chart 616. The computing device 102a can receive the EOS report (342). For example, the EOS report can be a web page that includes the EOS report and that can be executed by the web browser application 110. The computing device 102a can display the EOS report (344). For example, with the exception of the chart 616, the computing device 102a can display the report 600.

In addition, the computer system 150 can send the survey data to the computer system 140 (346). For example, the survey application 182 can access the survey data 160 included in the repository 152b and send the survey data to the computer system 140. The computer system 140 can receive the survey data (348). The computer system 140 can store the survey data in the repository 142b as survey data 144 (350). An enhanced end-of-survey (EEOS) report generator 124 can access the survey data 144 to generate an EEOS report.

In some implementations, referring to FIG. 1, if the survey is stored on the computer system 140 in the repository 142a, the computer system 140 can provide the survey to the computing device 102a. In these implementations, for example, the survey may be provided as a file in an email attachment to a user. The user can populate the survey, save it as a file, and return it to the administrator by attaching the completed survey to an email addressed to the administrator. In these implementations, the completed survey can be stored in the repository as survey data 144.

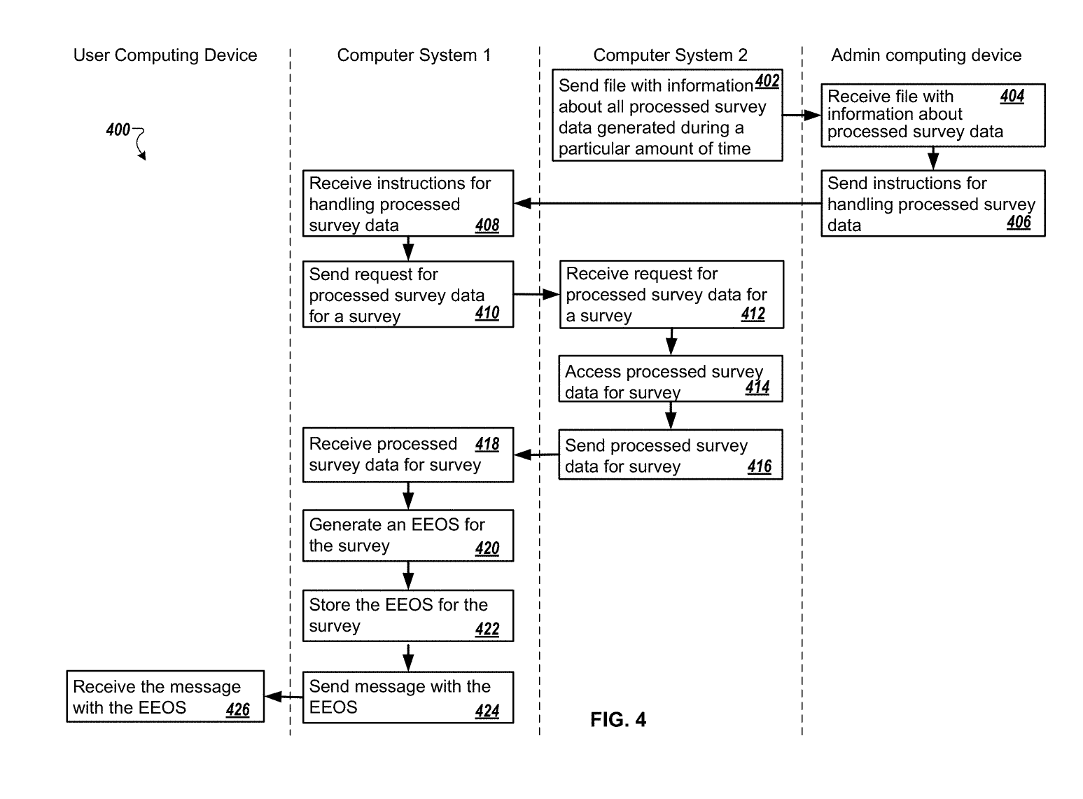

FIG. 4 is a swimlane diagram showing interactions 400 between a user computing device (e.g., the computing device 102a), a first computer system (e.g., the computer system 140), a second computer system (e.g., the computer system 150), and an administrator computing device (e.g., the computing device 102b).

Referring to FIG. 1, the computer system 150 can send a communication to the administrative user of the computing device 102b that includes a file with information about survey data received and processed during a particular time period (402). The survey data can be associated with individual surveys received from users. For example, the survey application 182 can access the processed survey data 154 and/or the EOS reports 158 included in the repository 152b to determine surveys received during a particular period of time (e.g., in the last week, in the last month, in the last 24 hours). The survey application 182 can automatically generate the file on a periodic basis (e.g., weekly, monthly, daily, respectively).

The computing device 102b can receive the file that includes the information about the received and processed survey data (404). The computing device 102b can send instructions to the computer system 140 for the handling of all processed survey data for the surveys included in the file during the time period (406). The instructions can include (i) requesting the processed survey data from the computer system 150 for each survey identified in the file, (ii) generating an EEOS for the survey using the processed survey data, and (iii) sending a message to a user that includes the EEOS.

The computer system 140 can receive the instructions for the handling of all processed survey data for the surveys included in the file during the time period (408). The computer system 140 can request the processed survey data for a particular survey identified in the file as received and processed during the particular time period (410). The computer system 150 can receive the request for the processed survey data for the particular survey (412). The computer system 150 can access the processed survey data 154 included in the repository 152b to obtain the requested process survey data for the particular survey (414). The computer system 150 can send the processed survey data for the particular survey (416). The computer system 140 can receive the processed survey data for the particular survey (418).

For example, an EEOS report generator 124 included in the server 142a can be executed. For example, the CPU 132 can execute instructions included in the EEOS report generator 124. An EEOS report generator 124 can use the processed survey data for the particular survey to generate an EEOS report (e.g., the EEOS report 600) (420). The EEOS report includes the chart 616. The computer system 140 can store the EEOS report in the repository 142b as EEOS reports 148 (422). If the information for a user that completed the survey is available, the computer system 140 can send the EEOS report to the user in a message to the user (424). For example, referring to FIG. 5B, if a user provides the user information 526 in the innovation readiness assessment survey 500, the computer system 140 can store the user information 526 with the survey data in the repository 142b in the survey data. The user information 526 (as well as other information included in the survey response) can be stored in association with the completed survey.

The computing device 102a of the user can receive the message that includes the EEOS (426). In some cases, the user may view the EEOS on the display device 120 on receiving the message.

In some cases, the steps 408 through 424 can be performed for each survey included in the file. The computer system 140 can then send messages to each organization associated with a survey that can include an EEOS report.

FIGS. 5A-B show an example innovation readiness assessment survey 500. The survey 500 can include one or more questions in multiple sections. A demographic section 502 can include one or more questions related to the demographics of the organization. For example, question ID1 504 is a question related to the size of the organization. As shown in FIGS. 5A-B, a numerical value (e.g., numerical values 506a-c) is associated with each answer. The question ID and numerical value for the answer can be included in the survey data for later use in the analysis of the data for reporting.

A people section 508 can include one or more questions related to the demographics of the organization. For example, question ID72 510 is a question related to the availability of design talent within the organization. A numerical value (e.g., numerical values 512a-e) is associated with each answer. The question ID and numerical value for the answer can be included in the survey data for later use in the analysis of the data for reporting. For example, the numerical value of the answer to question ID72 510 can indicate a level of design readiness of the organization with respect to the criteria included in the question.

A process section 514 can include one or more questions related to the current processes being implemented and practiced within the organization. For example, question ID45 516 is a question related to the awareness of the design organization of the processes in practice within the organization that aligned with corporate strategy. A numerical value (e.g., numerical values 518a-e) is associated with each answer. The question ID and numerical value for the answer can be included in the survey data for later use in the analysis of the data for reporting. For example, the numerical value of the answer to question ID45 516 can indicate a level of design readiness of the organization with respect to the criteria included in the question.

A place section 520 can include one or more questions related to the spaces and workplaces within the organization. For example, question ID55 522 is a question related to the availability of creative, collaborative workplaces within the organization. A numerical value (e.g., numerical values 524a-e) is associated with each answer. The question ID and numerical value for the answer can be included in the survey data for later use in the analysis of the data for reporting. For example, the numerical value of the answer to question ID55 522 can indicate a level of design readiness of the organization with respect to the criteria included in the question.

Once the user has completed the survey, the user can optionally provide user information 526 in order to receive a copy of the completed survey results. For example, referring to FIGS. 6A-C, the user can provide an email address so that an EEOS report can be sent to the user.

FIGS. 6A-C show an example enhanced version of an end-of-survey report (an EEOS report 600). Referring to FIG. 6A, the executive summary 602 can include an indication of how design-centric the organization is (e.g., an overall score 604). The executive summary 602 can include individual assessment scores for each measureable pillar to achieving a culture of innovation (e.g., people assessment score 606, process assessment score 608, and place assessment score 610).

FIGS. 7A-B show example table 700 and example table 710. Referring to FIG. 7A, the table 700 shows a score column 702 that includes respective scores for each question listed in a question column 704. A question number column 706 includes a respective number for each question listed in the question column 704. In some implementations, the question number listed in the question number column 706 for the respective question listed in the question column 704 can be the same as a number for the question in the survey. In some implementations, the question number listed in the question number column 706 for the respective question listed in the question column 704 can be different than a number for the question in the survey.

The table 700 can include entries for each question included in the survey (e.g., the survey 500). For example, the table 700 can include n entries for questions related to the people pillar, y entries for questions related to the process pillar, and z entries for questions related to the place pillar. In some implementations, each question entry in the table 700 corresponds to (correlates with) a question included in the survey.

Referring, for example, to FIG. 5A, each answer to each question included in the survey 500 has an associated score. Referring to FIG. 7A and FIG. 5A, for each question entry in the question column 704 there is an associated score in the score column 702. In addition, the question entries included in the question column 704 are grouped according to pillar. A brief description of the content of the question is included in each question entry in the question column 704.

For example, the question ID72 510 can be question row entry 708 in the table 700. A user can select answer 528 for question ID72 510. The answer 528 has an associated numerical value 512b that is entered as score 730. For example, the question ID45 516 can be question row entry 712 in the table 700. A user can select answer 530 for question ID45 516. The answer 530 has an associated numerical value 518c that is entered as score 714. For example, the question ID55 522 can be question row entry 716 in the table 700. A user can select answer 532 for question ID55 522. The answer 532 has an associated numerical value 524a that is entered as score 718.

For example, the sum of the scores for the questions can be computed as a total raw score for the survey. Referring to FIG. 7B, the total raw score can be used to identify an assessment stage for the organization (e.g., an assessment stage 612 as shown in FIG. 6A). The example table 710 shown in FIG. 7B assumes a total of 22 questions for the three measurable pillars. In some implementations, there can be more than 22 questions. In some implementations, there may be less than 22 questions. In some implementations, each pillar can include the same number of questions. In some implementations, each pillar can include a different number of questions.

The total number of questions can be used to determine a percentage for each raw score and stage. The table 710 includes a raw score column 720, a percentage column 722, and a stage column 724. Referring to FIG. 6A, a percentage score 614 for the EEOS report 600 can be determined using the table 710.

In some implementations, in addition or in the alternative a standard deviation can be calculated for each score that can identify a measure of deviation for a particular score for a question from an average of the scores.

For example, a large assessment score (e.g., a large raw score, a large percentage score) can indicate that an organization is design-centric. The assessment results included in the EEOS report 600 can include a level (e.g., the assessment stage 612) at which the organization falls within a maturity model. For example, an assessment stage equal to four can indicate a higher level within a design-centric maturity model for an organization than an assessment stage equal to two.

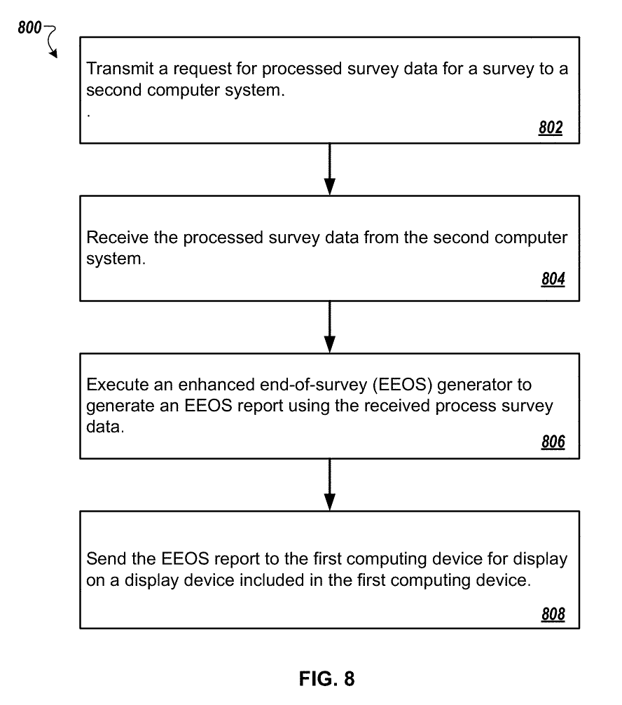

FIG. 8 is a flowchart that illustrates a method 800 for generating an enhanced end-of-survey report. In some implementations, the systems described herein can implement the method 800. For example, the method 800 can be described referring to FIG. 1.

A request for processed survey data for a survey is transmitted by a first computer system and to a second computer system (block 802). The second computer system can have access to a local repository for storing the processed survey data. The processed survey data can be generated by a survey data processor included in the second computer system. For example, an administrator using the computing device 102b can send instructions to the computer system 140 for the handling of processed survey data for one or more identified surveys. The instructions can include requesting the processed survey data from the computer system 150 for each identified survey, generating an EEOS for the survey using the processed survey data, and sending a message to a user that completed the survey that includes the EEOS.

The processed survey data is received by the first computer system from the second computer system (block 804). For example, the computer system 150 can send (provide, transmit) the processed survey data for the survey that is included in the repository 152b as processed survey data 154. An enhanced end-of-survey (EEOS) generator can be executed (block 806). The executing of the EEOS generator can generate (create) an EEOS report. The EEOS generator can generate the EEOS report using (based on) the received process survey data. As described herein, the EEOS report can information about an innovation readiness for an organization. For example, FIGS. 6A-C show an example EEOS report.

The EEOS report can be sent to the first computing device for display on a display device included in the first computing device (block 808). For example, the EEOS report 600 can be displayed on the display device 120 included in the computing device 102a.

The assessment results included in an EEOS report can include an indication of barriers to organization readiness, and prescriptive details on how the organization can overcome the identified barriers in order to increase readiness of the organization for creating a culture of innovation. The executive summary (e.g., the executive summary 602) can include identified barriers for increasing design centricity, and strategies to consider for overcoming the barriers and increasing design centricity. In addition, further information can be provided to the organization for best practices for achieving an increased design-centric organization based on the survey results.

The identified barriers and prescriptive details can provide information about the people, processes, and places within an organization. For example, an identified barrier related to the people pillar can indicate that a new type of leadership for the organization may be required that can empower forming multidisciplinary teams across multiple organizations working on the same project at the same time. For example, an identified barrier related to the process pillar can indicate that an iterative user-centered design approach that can focus on human factors while considering business and IT factors equally throughout the entire process may be needed in order to drive innovation. For example, an identified barrier related to the places pillar can indicate that an inspirational space to foster collaboration between peers and with customers may be needed in order to drive innovation.

The design-centric readiness model can include identified measureable pillars to achieving a culture of innovation such as people, processes, and places. For example, the innovation readiness assessment tool can analyze characteristics associated with the people in the organization to determine if the right mix of skills is available to achieve design led innovation. For example, the innovation readiness assessment tool can analyze and evaluate current processes in place by the organization to determine if the processes implement and/or empower collaboration, discovery, and co-creation among the people in the organization. For example, the innovation readiness assessment tool can assess the current physical space of the organization to determine if the physical space promotes creativity among the people in the organization.

The innovation readiness framework stages can include, but are not limited to, interest, investment, engagement, and scaling. For example, an organization can show interest in becoming more of a design-centric organization by noticing a need for increased innovation within the organization. For example, an organization can show investment in becoming a design-centric organization by adopting design as an important aspect of innovation within the organization. For example, an organization can show that it is engaged in becoming a design-centric organization when innovation and design can be identified as becoming more a part of the day-to-day activities performed within the organization. For example, an organization can show that it is scaling more towards becoming a design-centric organization by increasing the ability for the organization to cope with and perform under the design-readiness model. For example, having people with the right mix of skills, implementing design-centric processes, and/or providing a physical space that promotes creativity can show that an organization is scaling towards becoming more design-centric.

It has been shown that great user experiences with the use of applications and for sale products offered by a company or organization can be a competitive advantage to the organization. The competitive advantage can differentiate one organization over another. Organizations that implement a design-centric process that uses design thinking across the company can be more successful at creating beneficial user experiences. The use of an innovation readiness framework and assessment tool, as described herein, can help an organization understand the importance of innovation and design thinking for the success of the organization. The innovation readiness framework and assessment tool can identify barriers within the organization that block the ability of the organization to create great user experiences.

In some cases, internal factors can influence business goals. A silo mentality can be identified where business (e.g., marketing, sales, human resources (HR), etc.) and information technology (IT) can be disconnected with little to no focus being placed on the needs of people both inside and outside of the organization (e.g., end users). In addition, low employee engagement can be identified where employees are not encouraged to make changes. In some cases, if an organization does not drive change, these factors may negatively impact the organization because an organization may react or respond to these issues rather than embrace them. Organizations can innovate through design in order to drive meaningful valuable change by focusing on the end user. Design thinking can be a method that may be applied by everyone in the organization. Design thinking also brings together desirability, feasibility, and viability with innovation as the sweet spot in the middle.

Many organizations may not know how to optimize the organization to foster a culture and environment of innovation. To successfully apply and implement design thinking within an organization, the organization can combine people, processes, and places to drive results and innovation. A design-centric readiness model, as described herein, can provide information and data related to measureable pillars within the organization. The innovation readiness framework and assessment tool can take the results of survey questions provided by an organization that are based on the design-centric readiness mode and, using a four-level maturity model (e.g., interest, investment, engagement, and scaling) can provide information about the readiness of the organization for implementing innovation and design thinking. In addition, the innovation readiness framework and assessment tool can determine a maturity level within the four-level maturity model.

Referring to FIG. 1, in some implementations, the computer system 140 and/or the computer system 150 can represent more than one computing device working together to perform server-side operations. For example, though not shown in FIG. 1, the system 100 can include a computer system that includes multiple servers (computing devices) working together to perform server-side operations. In this example, a single proprietor, company, or organization can provide the multiple servers. In some cases, the one or more of the multiple servers can provide other functionalities for the proprietor. In some cases, one or more of the servers may be provided by a vendor engaged by the proprietor.

In some implementations, the network 116 can be a public communications network (e.g., the Internet, cellular data network, dialup modems over a telephone network) or a private communications network (e.g., private LAN, leased lines). In some implementations, the computing devices 102a-b can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret the web application 128 (e.g., a browser-based application). The web browser application 110 can include a dedicated user interface (e.g., a web browser UI). The web application 128 can include code written in a scripting language, such as AJAX, JavaScript, VBScript, ActionScript, or other scripting languages. The web application 128 can display a web page in the web browser UI. For example, the web page can be for an innovation readiness assessment survey (e.g., the innovation readiness assessment survey 500 shown in FIGS. 5A-B).

In some implementations, the web browser application 170 can execute or interpret the web application 168 (e.g., a browser-based application). The web browser application 170 can include a dedicated user interface (e.g., a web browser UI). The web application 168 can include code written in a scripting language, such as AJAX, JavaScript, VBScript, ActionScript, or other scripting languages. The web application 168 can display a web page in the web browser UI.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
in a system comprising one or more computing devices in communication with one or more computer systems over a network:
transmitting, by a first computer system and to a second computer system, a request for processed survey data for a survey, the second computer system having access to a local repository for storing the processed survey data, the processed survey data being generated by a survey data processor included in the second computer system;
receiving, by the first computer system and from the second computer system, the processed survey data;
executing, by the first computer system, an enhanced end-of-survey generator for generating an enhanced end-of-survey report using the received process survey data, the enhanced end-of-survey report including information about an innovation readiness for an organization; and
sending, by the first computer system and to the first computing device, the enhanced end-of-survey report for display on a display device included in the first computing device.

2. The method of claim 1, wherein generating the processed survey data by the survey data processor includes identifying a score for each answer to each question included in the survey.

3. The method of claim 2, wherein generating the processed survey data by the survey data processor further includes calculating a raw score using the identified scores for each answer to each question included in the survey.

4. The method of claim 3, wherein generating the processed survey data by the survey data processor further includes:
calculating a percentage score; and
calculating a stage.

5. The method of claim 4, wherein the raw score, the percentage score, and the stage represent innovation readiness for an organization.

6. The method of claim 1, further including receiving, by the first computer system and from a second computing device, instructions for handling the processed survey data prior to transmitting a request for processed survey data for the survey.

7. The method of claim 1, further including storing the enhanced end-of-survey report in a local repository accessible by the first computer system.

8. A non-transitory, machine-readable medium having instructions stored thereon, the instructions, when executed by a processor, cause a first computer system to:
transmit, by the first computer system and to a second computer system, a request for processed survey data for a survey, the second computer system having access to a local repository for storing the processed survey data, the processed survey data being generated by a survey data processor included in the second computer system;
receive, by the first computer system and from the second computer system, the processed survey data;
execute an enhanced end-of-survey generator for generating an enhanced end-of-survey report using the received process survey data, the enhanced end-of-survey report including information about an innovation readiness for an organization; and
send, by the first computer system and to the first computing device, the enhanced end-of-survey report for display on a display device included in the first computing device.

9. The medium of claim 8, wherein generating the processed survey data by the survey data processor includes identifying a score for each answer to each question included in the survey.

10. The medium of claim 9, wherein generating the processed survey data by the survey data processor further includes:
calculating a raw score using the identified scores for each answer to each question included in the survey.

11. The medium of claim 10, wherein generating the processed survey data by the survey data processor further includes:
calculating a percentage score; and
calculating a stage.

12. The medium of claim 11, wherein the raw score, the percentage score, and the stage represent innovation readiness for an organization.

13. The medium of claim 8, wherein the instructions, when executed by a processor, further cause a first computer system to receive, by the first computer system and from a second computing device, instructions for handling the processed survey data prior to transmitting a request for processed survey data for the survey.

14. The medium of claim 8, wherein the instructions, when executed by a processor, further cause a first computer system to store the enhanced end-of-survey report in a local repository accessible by the first computer system.

15. A system comprising:
a network;
a first computer system including an enhanced end-of-survey generator;
a second computer system including a second repository and a survey data processor, the second repository including stored processed survey data; and
a first computing device including a display device, the first computer system configured to:
transmit a request for processed survey data for a survey to the second computer system by way of the network, the second computer system accessing the second repository to retrieve the processed survey data, the processed survey data being generated by the survey data processor;
receive the processed survey data from the second computer system;
execute the enhanced end-of-survey generator, the executing generating an enhanced end-of-survey report using the received process survey data, the enhanced end-of-survey report including information about an innovation readiness for an organization; and
send the enhanced end-of-survey report to the first computing device by way of the network for display on the display device.

16. The system of claim 15, wherein generating the processed survey data by the survey data processor includes identifying a score for each answer to each question included in the survey.

17. The system of claim 16, wherein generating the processed survey data by the survey data processor further includes calculating a raw score using the identified scores for each answer to each question included in the survey.

18. The system of claim 17, wherein generating the processed survey data by the survey data processor further includes:
calculating a percentage score; and
calculating a stage.

19. The system of claim 18, wherein the raw score, the percentage score, and the stage represent innovation readiness for an organization.

20. The system of claim 15, wherein the first computer system includes a first repository; and
wherein the first computer system is further configured to store the enhanced end-of-survey report in the first repository.
